(19) United States
(12) Patent Application Publication
(10) Pub. No.: US 2002/0042781 A1
(43) Pub. Date: Apr. 11, 2002

(54) Universal and interoperable system and method utilizing a universal cardholder authentication field (UCAF) for authentication data collection and validation

(76) Inventors: Arthur D. Kranzley, Pound Ridge, NY (US); Stephen W. Orfei, Katonah, NY (US); Bruce J. Rutherford, Stamford, CT (US)

Correspondence Address: BAKER & BOTTS, 30 ROCKEFELLER PLAZA, NEW YORK, NY, 10112

(21) Appl. No.: 09/963,274

(22) Filed: Sep. 26, 2001

Related U.S. Application Data
(60) Provisional application No. 60/235,738, filed on Sep. 27, 2000.

(51) Int. Cl. G06F 17/60

(52) U.S. Cl. 705/75; 705/44; 705/39

(57) ABSTRACT

A method is provided for conducting a financial transaction by a consumer over a communication network and involving a payment network having an issuer for authorizing the transaction based on standard authorization criteria including transaction data and based on a positive authentication of the consumer. The method comprises: utilizing one of a plurality of authentication mechanisms for providing the consumer cardholder authentication data; utilizing a universal cardholder authentication field for transmitting to a merchant the cardholder authentication data regardless of the authentication mechanism utilized; generating an authorization request including the cardholder authentication data and forwarding that request over the payment network for verification by the issuer.

### BACKGROUND

A wide variety of non-interoperable security solutions have been deployed by technology companies and financial institutions to help in the authentication of consumer's during purchases at Internet merchant sites. Some solutions have utilized pseudo account numbers while others have attempted to utilize public key infrastructure (PKI) but have faced challenges associated with costs for wide scale deployment as well as merchant activation, consumer awareness and interoperability challenges.

These efforts have yet to reach wide scale deployment. Their existence, however, has pointed to the need for a universal and interoperable method of collecting cardholder authentication data at the merchant virtual point of sale. Such a solution would be independent of the actual authentication scheme utilized and add value to the parties to the transaction by serving as the universal method of collection for the authentication data. Once collected by the merchant, the authentication data can be passed on to the payment networks for authentication by the issuer of the payment card account.

### SUMMARY OF INVENTION

To accomplish this objective, a Universal Cardholder Authentication Field (UCAF) may be utilized to provide a mechanism for collecting cardholder authentication data at the merchant virtual point of sale. The UCAF mechanism can exist as either a hidden or visible field on the merchant order form that can be completed either directly by the consumer or electronically through the use of digital wallets and smart cards that may interface with personal computers or other access devices including wireless telephones, and personal digital assistants (“PDAs”). The UCAF is not verified by the merchant but instead collected and passed to the payment process for verification within the payment card authorization process. The UCAF data collected by the merchant will be included in the authorization request and validated by the issuer of the consumer's payment card or account. The issuer will be responsible for authorizing payment or declining payment based on a positive authentication of the consumer in addition to standard authorization criteria already established.

This UCAF process can be utilized for multiple payment brands and offers one uniform method for collecting cardholder authentication data at the merchant regardless of the authentication mechanism deployed by the issuer of the payment card account. This data may consist of information such as digital certificate serial numbers, digital signatures, application cryptograms, passwords, or other shared secrets that exist between a payment cardholder and the issuer of that account.

Accordingly, a method is provided for conducting a financial transaction with a merchant by a consumer over a communication network and involving a payment network having an issuer for authorizing the transaction based on standard authorization criteria including transaction data and based on a positive authentication of the consumer. The method comprises: utilizing one of a plurality of authentication mechanisms for providing the consumer with cardholder authentication data; utilizing a universal cardholder authentication field for transmitting to the merchant the cardholder authentication data regardless of the authentication mechanism utilized; generating an authorization request including the cardholder authentication data in the universal cardholder authentication field; forwarding the request over the payment network; and verifying by the issuer the authentication data and authorizing the transaction based on the positive verification and on the standard criteria.

### DESCRIPTION OF THE DRAWINGS

Further objects, features and advantages of the invention will become apparent from the following detailed description taken in conjunction with the accompanying figure showing a preferred embodiment of the invention, on which:

FIG. 1 is a flow diagram of the system illustrating the collection, flow and authentication of information among a cardholder, a merchant, acquirer and issuer, in accordance with a preferred embodiment of the present invention.

### PREFERRED EMBODIMENT

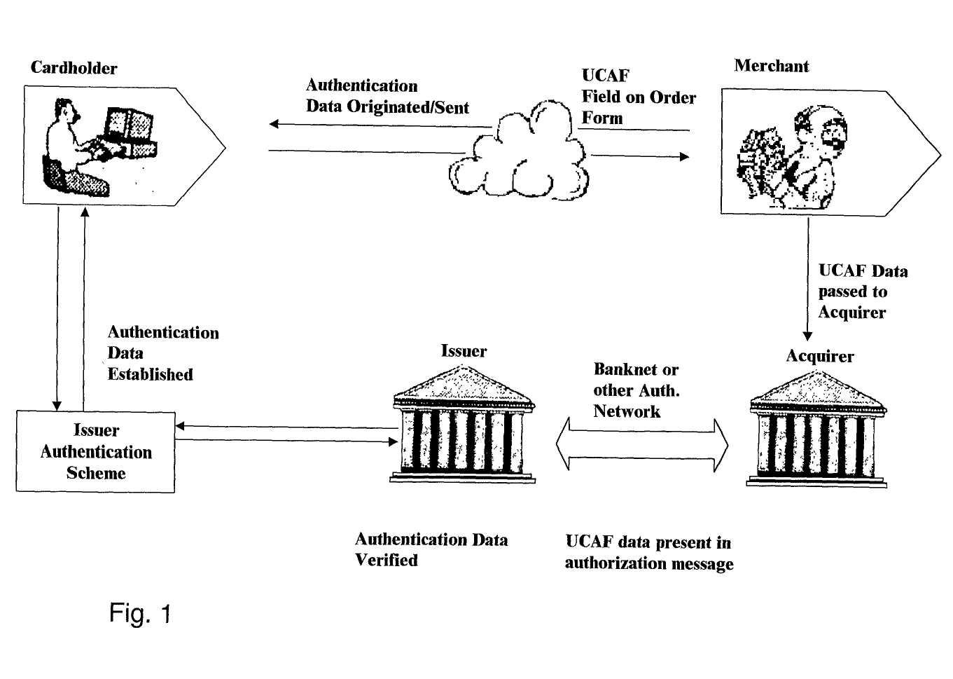

As depicted in FIG. 1, regardless of the access device (personal computer, wireless phone, PDA, etc), consumers must establish authentication data with their account issuer through a variety of existing authentication schemes including digital wallet servers, smart cards, and utilizing secure electronic transaction protocols such as SET and SSL. This process falls outside of the scope of UCAF and UCAF relies upon an authentication scheme being established between the issuer and their account holders.

In accordance with the present invention, merchants modify their web forms for order and payment information to support a new field capable of collecting UCAF data from the various account holder authentication schemes being deployed by technology companies and financial institutions. This UCAF field may either be a visible or hidden field capable of being populated. After an account holder has browsed the merchant's site and selected items for purchase, the UCAF field will need to be populated with the appropriate authentication data in addition to standard purchase information such as billing address, shipping address, card account number and expiration date.

There are a variety of mechanisms that may be utilized to populate the UCAF field on the order form including manual key entry and digital wallets including both client-based and server-based wallet designs. Similarly, smart cards may be utilized to generate the UCAF data. The UCAF data could consist of information such as certificate serial numbers, digital signatures, application cryptograms, passwords or other shared secrets between the account holder and the account issuer. In the preferred embodiment, once this data is collected at the merchants' virtual point of sale, the merchant must pass the data exactly as collected to their acquirer to be processed as part of the payment card authorization request.

Preferably, as shown in FIG. 1, the acquirer receives the UCAF data from the merchant and populates the data as received into the authorization message per the specifications made available by a particular payment brand. This data must be included in the actual authorization request forwarded on to the account issuer for verification and purchase authorization. Preferably, when an authorization request containing UCAF data is sent to the issuer, the issuer must verify that the authentication data matches the information previously established with the account holder. If the data is verified, a response is provided back to the acquirer indicating that the cardholder was authenticated and whether the purchase was authorized.

The immediate application is to allow payment brands to provide a universal mechanism for merchants to collect cardholder authentication data and provide for back end verification of the data by the issuer of the card account. Regardless of the authentication scheme or access device, the UCAF concept can be used as the basis for capturing the authentication data to be passed on for verification through the purchase authorization process.

Although preferred embodiments of the invention have been disclosed for illustrative purposes, those skilled in the art will appreciate that many additions, modifications, and substitutions are possible without departing from the true scope and spirit of the invention as defined by the accompanying claims.

We claim:

1. A method for conducting a financial transaction with a merchant by a consumer over a communication network and involving a payment network having an issuer for authorizing said transaction based on standard authorization criteria including transaction data and based on a positive authentication of said consumer, said method comprising:
utilizing one of a plurality of authentication mechanisms for providing said consumer with cardholder authentication data;
utilizing a universal cardholder authentication field for transmitting to said merchant said cardholder authentication data regardless of the authentication mechanism utilized;
generating an authorization request including said cardholder authentication data;
forwarding said request over the payment network; and
verifying by said issuer said authentication data and authorizing said transaction by said issuer based on said positive verification and on said standard criteria.

2. The method of claim 1 wherein said payment network includes a merchant's acquirer and further including the steps of passing said authentication field data along with said transaction data to said acquirer and generating by said acquirer said authorization request.

3. The method of claim 2 wherein said authentication data comprises at least one of digital certificate serial numbers, digital signatures, application cryptograms and passwords established through at least one of a digital wallet server and smart card.

4. The method of claim 3 wherein said consumer utilizes an account number for said transaction and said account number has an associated expiration date and an associated available credit line and wherein said standard authorization criteria comprises an evaluation of said expiration date and said available credit.

5. The method of claim 4 wherein said universal cardholder authentication field is automatically populated with said cardholder authentication data.
